(19) United States
(12) Patent Application Publication
(10) Pub. No.: US 2022/0184781 A1
(43) Pub. Date: Jun. 16, 2022

(54) FASTENER FEEDING DEVICE FOR DRIVING TOOL

(71) Applicant: OMG, Inc., Agawam, MA (US)

(72) Inventors: Jonathan Charles Wenderoth, Boston, MA (US); Kurt Michael Maw, Salem, MA (US); Cedric Kevin Delmy, Chicopee, MA (US); Peter J. Shadwell, Longmeadow, MA (US); Joshua S. Kelly, Longmeadow, MA (US)

(21) Appl. No.: 17/552,942

(22) Filed: Dec. 16, 2021

Related U.S. Application Data
(60) Provisional application No. 63/126,243, filed on Dec. 16, 2020.

(51) Int. Cl. B25B 23/04

(52) U.S. Cl. CPC B25B 23/04; B25B 21/002

(57) ABSTRACT

Disclosed herein is a fastener feed device. The device includes a guide tube, a feed tube, a plate feed actuator, a structural member, a slide roller, a latch, an actuation member, a shank stop lever, and a head stop lever. The feed tube receives a fastener. The plate feed actuator is proximate the guide tube. The structural member includes a vertical slot. The slide roller is movable within the vertical slot. The latch is connected to the plate feed actuator. The actuation member includes a head kicker portion, a latch slot, and a lever portion. The head kicker portion is received at the opening. The latch is configured to extend through the latch slot. The lever portion is proximate the slide roller. The shank stop lever is connected to the actuation member. The head kicker portion, the shank stop lever, and the head stop lever interact with the fastener.

### CROSS-REFERENCE TO RELATED APPLICATION

This application claims priority to U.S. Provisional Application No. 63/126,243, titled Fastener Feeding Device For Driving Tool, filed on Dec. 16, 2020, the entire content of which is incorporated herein by reference.

### BACKGROUND

The disclosure relates to a mechanism for feeding screws, in particular screws of various lengths from 1.25″ to 10″ in length and from #12 to #15 in diameter. Various tools, such as plate feeding tools, used in roofing applications for example, are used in connection with fasteners to attach the plates to a roofing structure.

Accordingly, there is a need to provide an improved mechanism for feeding screws to the tool while maintaining robust and reliable configurations.

### SUMMARY

According to one aspect of the disclosure, as fastener feed device is disclosed. The fastener feed device includes a guide tube, a feed tube, a plate feed actuator, a structural member, a slide roller, a latch, an actuation member, a shank stop lever, and a head stop lever. The feed tube is on one side of the guide tube. The feed tube is configured to receive a fastener. The feed tube includes an opening. The plate feed actuator is proximate the guide tube. The structural member is adjacent the plate feed actuator. The structural member includes a vertical slot. The slide roller is movable within the vertical slot of the structural member. The latch is connected to the plate feed actuator. The actuation member includes a head kicker portion, a latch slot, and a lever portion. The head kicker portion is received at the opening of the feed tube. The latch is configured to extend through the latch slot. The lever portion is proximate the slide roller. The shank stop lever is connected to the actuation member. The head stop lever is between the shank stop lever and the feed tube. The head kicker portion, the shank stop lever, and the head stop lever are configured to interact with the fastener.

According to another aspect of the disclosure, as fastener feed device is disclosed. The fastener feed device includes a guide tube, a feed tube, a plate feed actuator, a structural member, a slide roller, a latch, an actuation member, a shank stop lever, and a head stop lever. The feed tube is on one side of the guide tube. The feed tube is configured to receive a fastener. The feed tube includes an opening. The plate feed actuator is proximate the guide tube. The structural member is adjacent the plate feed actuator. The structural member includes a vertical slot. The slide roller is movable within the vertical slot of the structural member. The latch is connected to the plate feed actuator. The actuation member includes a head kicker portion, a latch slot, and a lever portion. The head kicker portion is received at the opening of the feed tube. The latch is configured to extend through the latch slot. The lever portion is proximate the slide roller. The shank stop lever is connected to the actuation member. The head stop lever is between the shank stop lever and the feed tube. The head kicker portion, the shank stop lever, and the head stop lever are connected to and configured to be controlled by a single lever portion of the actuation member.

According to another aspect of the disclosure, as fastener feed device is disclosed. The fastener feed device includes a guide tube, a feed tube, a plate feed actuator, a structural member, a slide roller, a latch, an actuation member, a shank stop lever, and a head stop lever. The feed tube is on one side of the guide tube. The feed tube is configured to receive a fastener. The feed tube includes an opening. The plate feed actuator is proximate the guide tube. The structural member is adjacent the plate feed actuator. The structural member includes a vertical slot. The slide roller is movable within the vertical slot of the structural member. The latch is connected to the plate feed actuator. The actuation member includes a head kicker portion, a latch slot, and a lever portion. The head kicker portion is received at the opening of the feed tube. The latch is configured to extend through the latch slot. The lever portion is proximate the slide roller. The shank stop lever is connected to the actuation member. The head stop lever is between the shank stop lever and the feed tube. The head kicker portion, the shank stop lever, and the head stop lever are configured to allow a head of an upside down fastener to remain between a first notch and a second notch of the head stop lever when the upside down fastener is in the feed tube.

### BRIEF DESCRIPTION OF THE DRAWINGS

FIG. 1 is an exterior left side plan view of an installation tool incorporating an embodiment of a fastener feed device according to aspects of the disclosure;

FIG. 2 is a perspective view of the fastener feed device of FIG. 1;

FIG. 3 is another perspective view of the fastener feed device of FIG. 1;

FIGS. 4-7 show various views of the screw feed mechanism at a top of travel position;

FIG. 8 is a side view of the screw feed mechanism in a mid travel position;

FIGS. 9-12 show various views of the screw feed mechanism at a full compression position;

FIG. 13 is a side view of the screw feed mechanism at the top of travel position;

FIG. 14 is a side view of the screw feed mechanism at a partial compression position;

FIG. 15 is a side view of the screw feed mechanism at a manual plate feed/maintenance position;

FIG. 16 is a side view of the screw feed mechanism at the top of travel position;

FIG. 17 is a side view of the screw feed mechanism at the full compression position (with an upside down fastener in the feed tube);

FIG. 18 is a side view of the screw feed mechanism at the top of travel position (with the upside down fastener in the feed tube);

FIG. 19 is a side view of the screw feed mechanism in the mid travel position (with the upside down fastener in the feed tube);

FIG. 20 is a side view of the screw feed mechanism at the full compression position (with the upside down fastener in the feed tube); and

FIG. 21 a side view of the screw feed mechanism at the top of travel position (with the upside down fastener in the feed tube).

### DETAILED DESCRIPTION

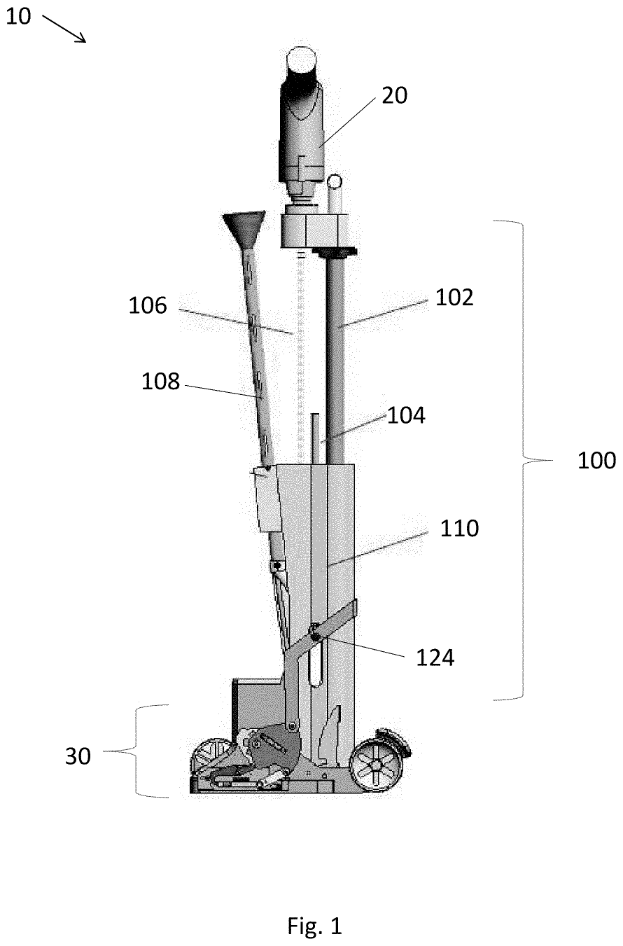

Referring to FIG. 1, a side view of a fastener installation and plate feeding tool 10 is shown. The fastener installation and plate feeding tool includes a motorized driver 20, a lower assembly 30, and an upper assembly 100. The upper assembly 100 mainly comprises a fastener feed device and the lower assembly 30 mainly comprises a plate feed device.

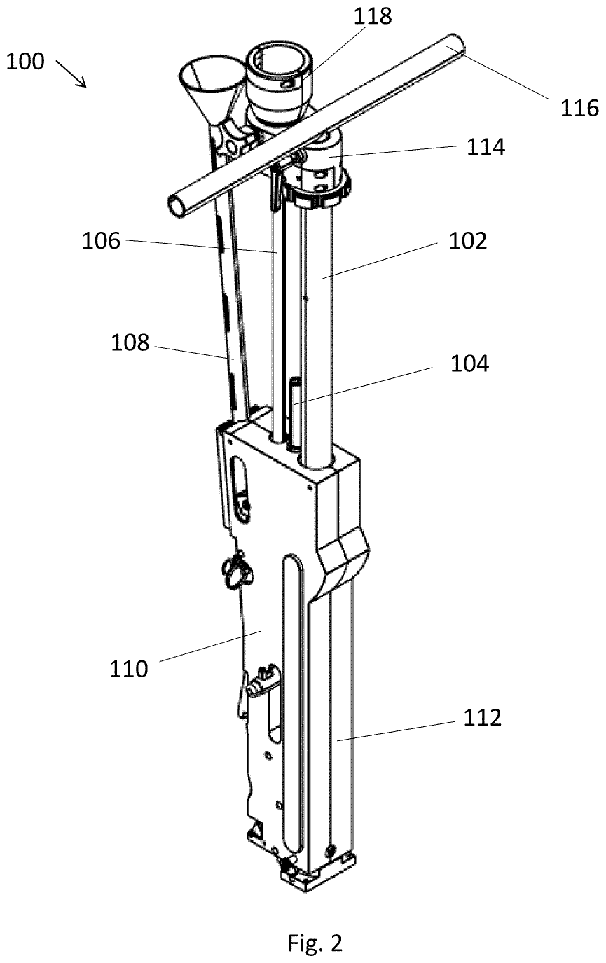

Referring now also to FIGS. 2, there is shown a perspective view of the fastener feed device 100 incorporating features of the disclosure. Although the fastener feed device 100 will be described with reference to the exemplary embodiments shown in the drawings, it should be understood that the fastener feed device 100 can be embodied in many alternate forms of embodiments. In addition, any suitable size, shape or type of elements or materials could be used.

The fastener feed device 100 includes a structural member 102, a plate feed actuator 104, a drive shaft 106, and a feed tube 108. The structural member 102, the plate feed actuator 104, and the drive shaft 106 are substantially parallel to each other and extend from a top end of clamshell housings 110, 112 which surround a lower stalk portion of the fastener feed device 100.

The fastener feed device 100 further comprises an upper tube mount 114 which supports the structural member 102 and provides mounting areas for a handle 116 and a driver adapter 118. According to some embodiments, the handle 116 may be an adjustable height handle (with an adjustable height range of six to twelve inches, for example). The driver adapter 118 is configured to be attached to a motorized driver and is aligned with an opening in the upper tube mount 114 which allows the drive shaft 106 to extend therethrough. According to some embodiments, the driver adapter 118 is configured to be removably attached to the motorized driver. In some other embodiments, the driver adapter 118 is configured to be fitted to the motorized driver just once. In yet further embodiments, any suitable attachment configuration between the driver adapter and the motorized driver may be provided. Additionally, and according to the various exemplary embodiments, the driver adapter 118 is configured to be removable from the upper tube mount (when required) along with the driver and the drive shaft.

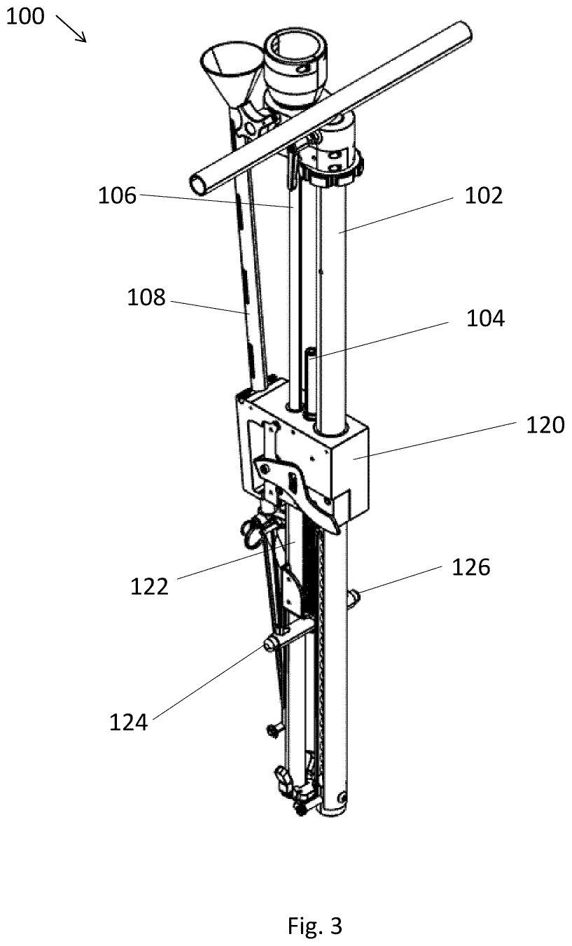

According to various exemplary embodiments, a middle tube mount 120 is provided for supporting the structural member 102, the plate feed actuator 104, and the feed tube 108 (see FIG. 3 illustrating a perspective view of the fastener feed device with the clamshell housings 110, 112 removed). Additionally, the middle tube mount 120 provides an opening for the drive shaft 106 to extend therethrough, and provides support and/or mounting areas for components of the fastener feed mechanism.

Still referring to FIGS. 1-3, the feed device mechanism controls the release of fasteners in the feed tube, and where the fasteners are inserted with the shank of the fastener preceding (below) the head so that the fasteners are stacked within the feed tube with the point of a fastener resting on the head of the next fastener in the stack. The feed tube 108 (which may include openings to allow an operator to see whether fasteners are present in the feed tube) is supported by the middle tube mount 120 such that the feed tube is at an acute angle relative to a guide tube 122. The fastener feed mechanism is arranged to release fasteners one at a time, allowing the fasteners to descend toward the lower end of the guide tube 122. The guide tube defines a vertical slot to receive each fastener, with the fasteners supported within the guide tube in alignment with an axis of the guide tube and a drive bit secured to the drive shaft. The structural member 102 (which includes a main spring) is spring biased toward an extended position in which the drive bit is above the slot where fasteners enter the guide tube 122. During operation of the fastener drive tool, an operator actuates the driver and presses down on a handle connected to the structural member. The rotating drive shaft moves downward toward a fastener in the guide tube 122, the drive bit engages a drive socket in the fastener and the fastener is driven out of a lower end of the guide tube 122 into a workpiece. It should be noted that the disclosed screw feed mechanism is illustrated as part of an installation tool configured to be operated from a standing position, but is not limited to this use.

The feed mechanism is operated in coordination with driving of a fastener in the guide tube 122. As mentioned above, the screw feed device is incorporated into a fastener driving tool that also feeds plates that are fastened to a roof structure by the fasteners. The plate feed actuation rod 104 includes a pair of arms 124, 126 that project laterally to engage linkages that operate the plate feed mechanism (see FIG. 1). Additionally, the plate feed actuation rod 104 is spring biased toward the top of its travel, and is pushed downward when an operator pushes downward on the handle 116 (when driving the fastener). According to various exemplary embodiments, the plate feed actuation rod 104 is pushed downward only during the bottom three inches (approximately) of travel of the handle 116 when the operator pushes downward on the handle 116. However in alternate embodiments, other movement configurations of the plate feed actuation rod and the handle may be provided. As will be discussed further below, the feed mechanism has three components that interact with the fasteners to ensure that the fasteners are reliably released one at a time at the correct time to allow the fasteners to enter the guide tube below the drive bit. A shank stop lever engages the shank of an upper fastener to prevent downward movement (allowing release of a lower fastener), a head stop lever engages the underside of a lower fastener (the fastener immediately below the upper fastener), and a head kicker is arranged to disengage the head of the lower fastener from the tip of an upper fastener to ensure the lower fastener actually drops when intended.

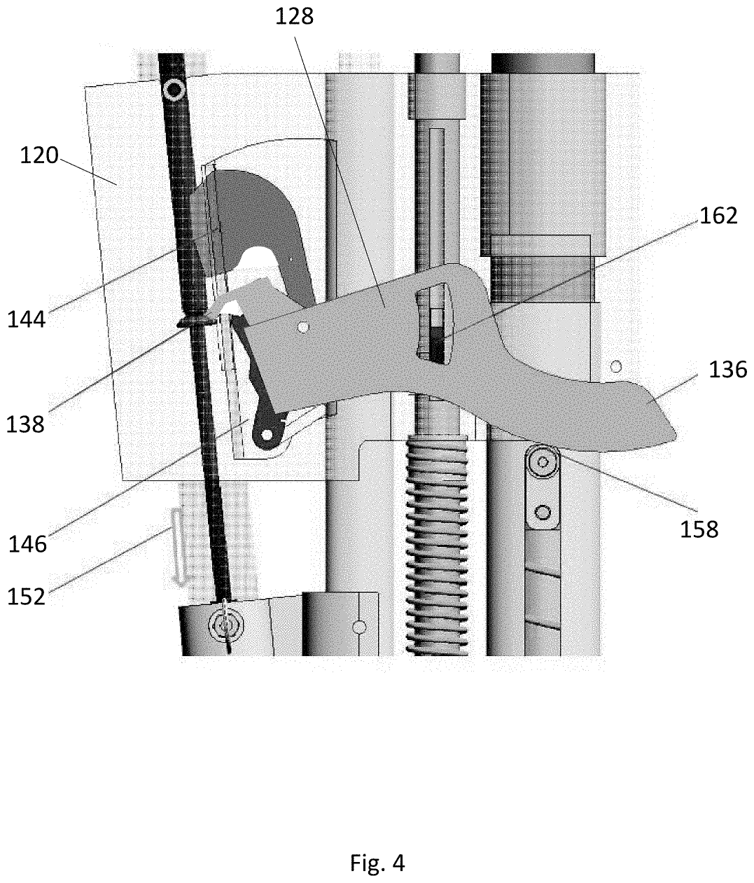

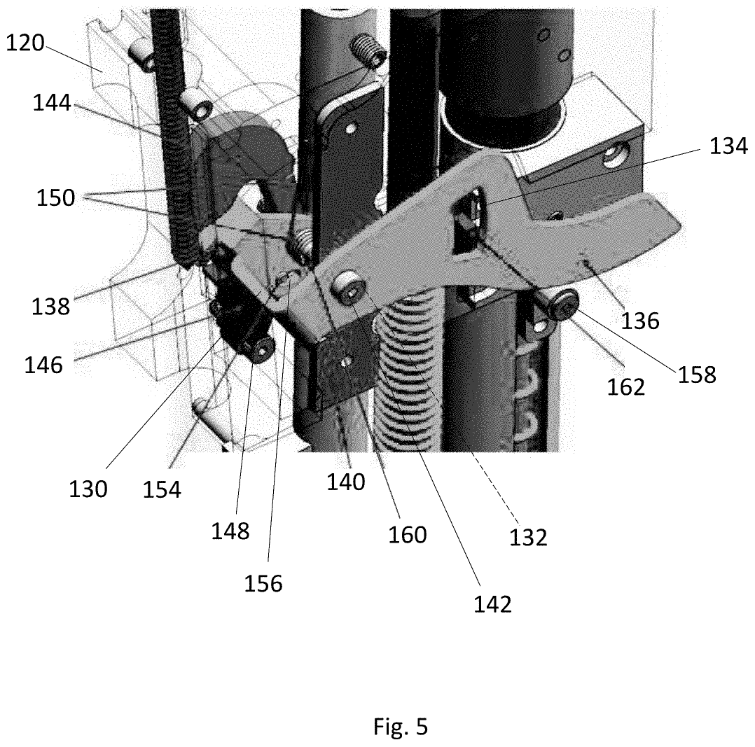

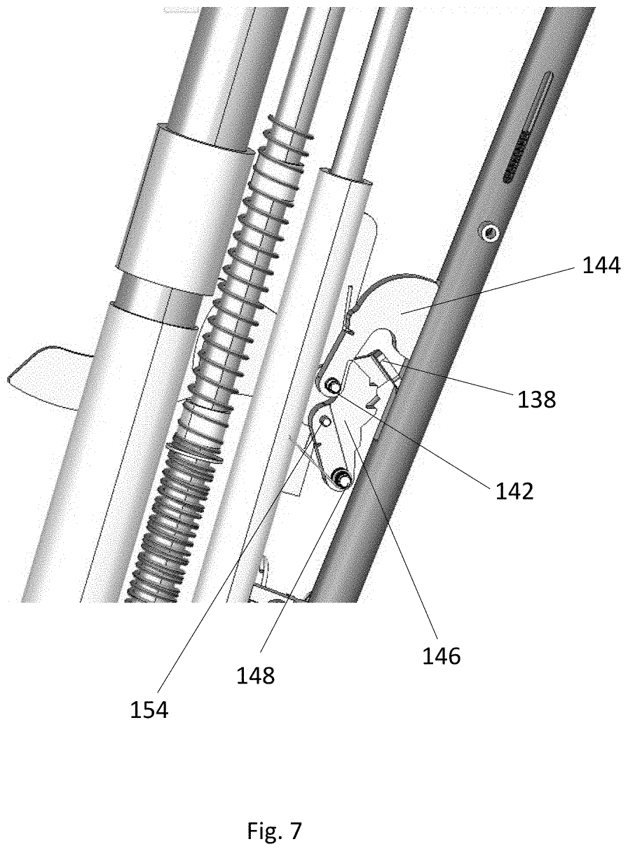

Referring now also to FIGS. 4-7, the screw feed mechanism is shown with an actuation member 128 at a top of travel position (i.e. when the operator is not pressing down on the handle 116). The actuation member 128 includes a general “U” shaped channel 130 with a mounting hole 132, a latch slot 134, and a lever portion 136 on one side of the general “U” shaped channel 130, and a head kicker portion 138 on the other side of the general “U” shaped channel 130. The actuation member 128 is pivotably mounted to a retaining plate 140 (via a fastener 142 extending through the mounting hole 132) which is secured to the middle tube mount 120. Additionally, a shank stop lever 144 is pivotably mounted to the actuation member 128 (via the fastener 142) [best seen in FIG. 7] and a head stop lever 146 is pivotably mounted to the middle tube mount 120 (via fastener 148) [also best seen in FIG. 7]. It should be understood that although the actuation member has been described above in connection with a general “U” shaped channel (having a mounting hole and a latch slot), a lever portion, and a head kicker portion, one skilled in the art will appreciate that the various exemplary embodiments are not necessarily so limited and that other alternate configurations are envisioned. Additionally, the pivotal mounting between the actuation member, the retaining plate, the shank stop lever, and/or the head stop lever mentioned above are provided as non-limiting mounting examples and other suitable mounting methods could be provided.

In this position, the shank stop lever 144 is engaged with the shank of the upper fastener (with spring 150 providing a force towards the fastener), and the head kicker portion 138 is engaged with the head of the lower fastener (such that the head of the lower fastener will disengage from the tip of the upper fastener to ensure the lower fastener actually drops/releases [see arrow 152] when intended). Additionally, in this position, the head stop lever 146 is disengaged (and a pin 154 and slot 156 connection between the head stop lever 146 and the actuation member 128 provides for appropriate motion).

Also in this position, the lever portion 136 of the actuation member 128 is in contact with a vertical slide roller 158. Spring 160 biases the actuation member in a clockwise direction (about the pivot point) when viewed from the perspective of FIG. 4, however in this position the vertical slide roller 158 maintains the actuation member 128 in the illustrated orientation.

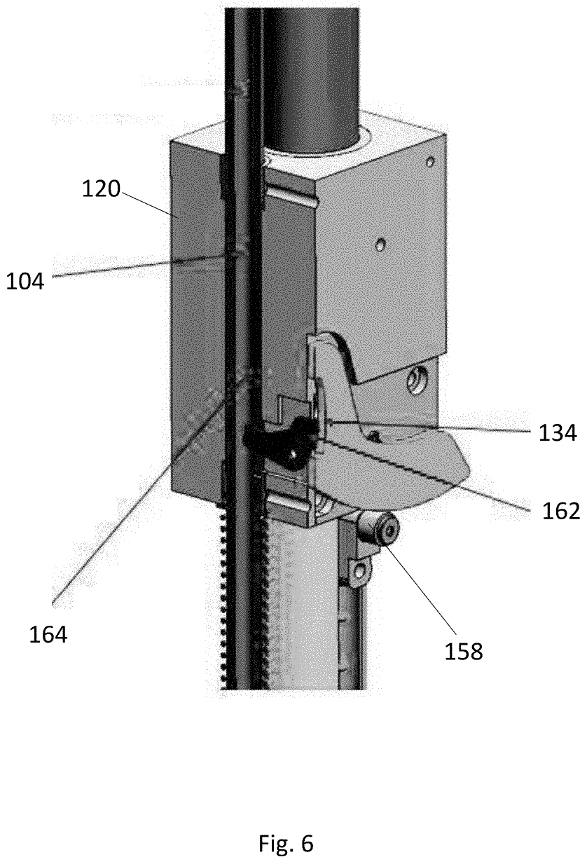

A full drive latch 162 is also provided with a pivotable connection to the middle tube mount 120 (best seen in FIG. 6). The full drive latch 162 is biased (with a torsion spring, for example) to have one end extending into a plate feed actuator slot 164, and an opposite end extending into the latch slot 134 of the actuator member 128.

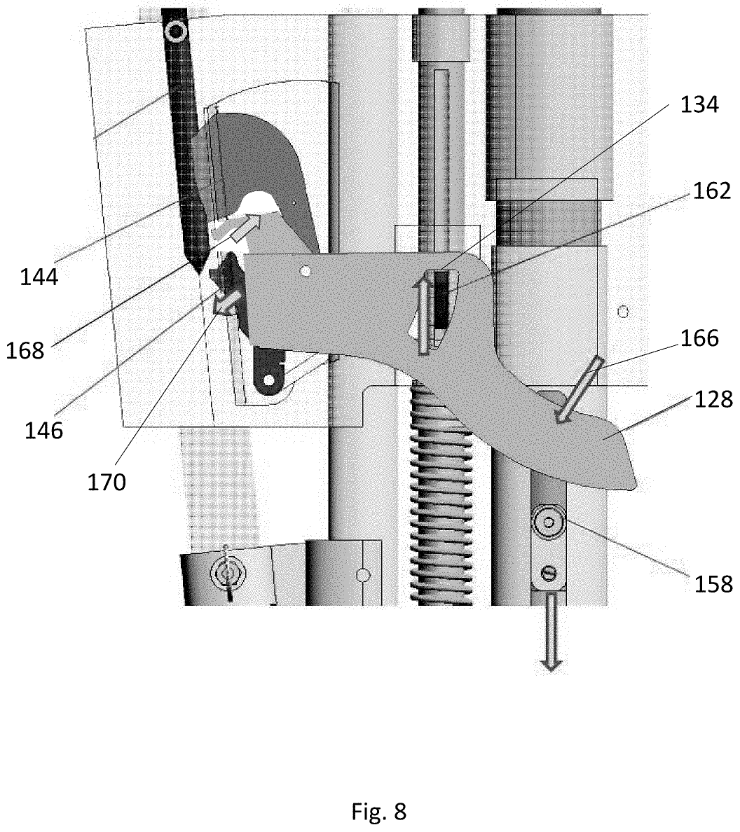

Referring now to FIG. 8, the screw feed mechanism is shown with an actuation member at a mid travel position (i.e. when the operator initially presses down on the handle 116). In this position, the vertical slide roller 158 is no longer in contact with the lever portion 136 of the actuation member 128, and the actuation member 128 pivots in a clockwise direction (see arrow 166). This causes the full drive latch 162 to catch the top portion of the latch slot 134 and prevents full swing of the actuation member 128. Additionally, the clockwise pivoting motion of the actuation member 128 causes the head kicker 138 to become disengaged (see arrow 168) and the head stop lever 146 to move towards direction 170. In this position (when the full drive latch 162 is supporting the actuation member 128 [at the latch slot 134], as shown in FIG. 8) the head stop lever 146 is pivoted to a full engagement position. Additionally, the shank stop lever 144 is also in a full engagement position.

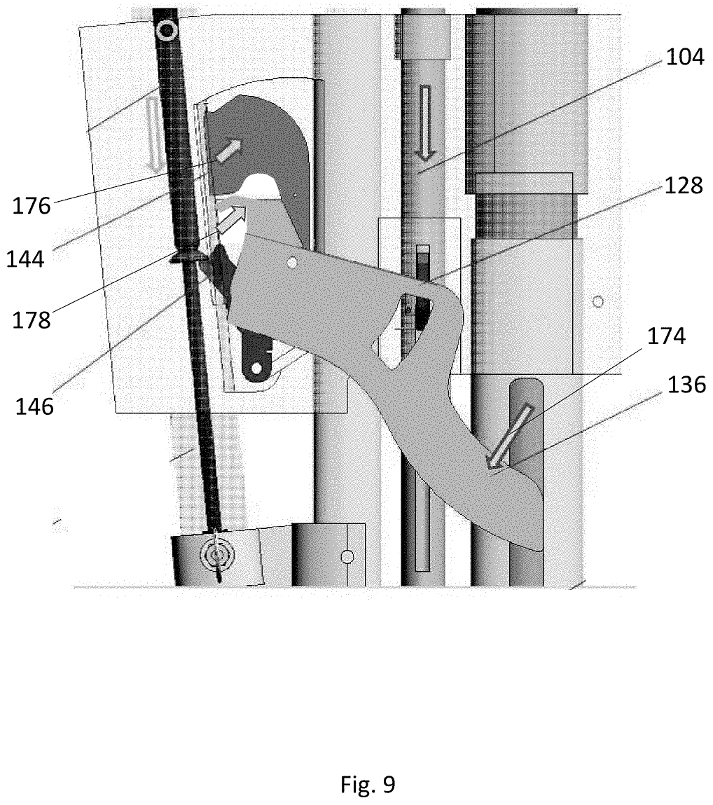

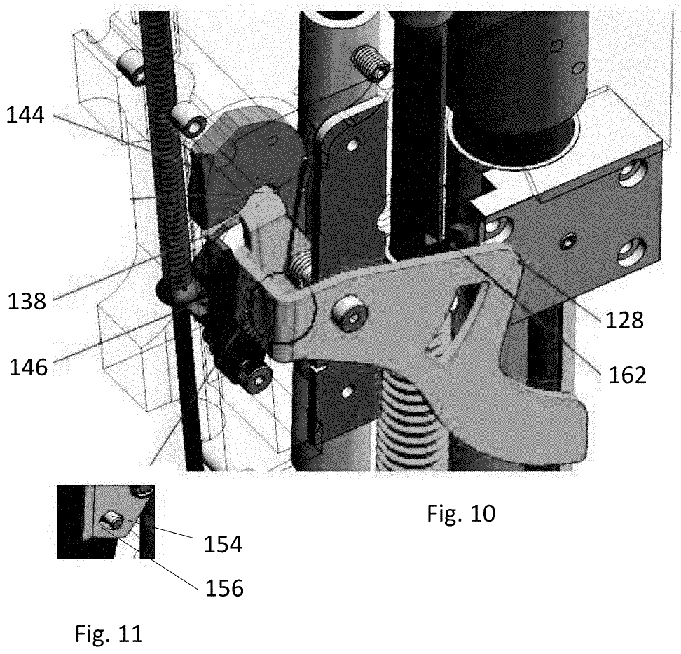

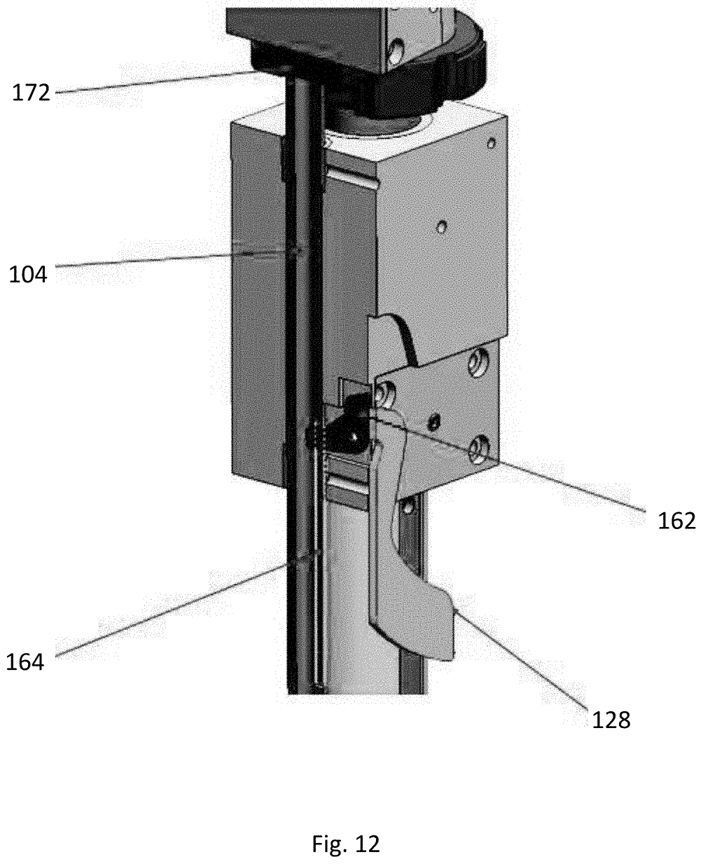

Referring now also to FIGS. 9-12, the screw feed mechanism is shown with the actuation member 128 at a full compression position (i.e. when the operator has pressed down on the handle 116 to fully compress the tool). In this position the vertical slide roller 158 is still no longer in contact with the lever portion 136 of the actuation member 128 and with the plate feed actuator compressed (due to contact with an adjustable depth stop 172), this causes the end of the groove 164 to contact to the end of the full drive latch 162 and pivot the latch to a retracted position. This retraction of the full drive latch 162 releases the actuation member 128 to extend to a full travel position (see arrow 174). With the full travel position of the actuation member 128, the head stop lever 146 remains in the full engagement position (and supports the underside of the fastener), while the shank stop lever 144 and the head kicker portion 138 are disengaged (see bias direction arrows 176, 178) and the pin 154 and slot 156 connection provides for appropriate motion (see FIG. 11).

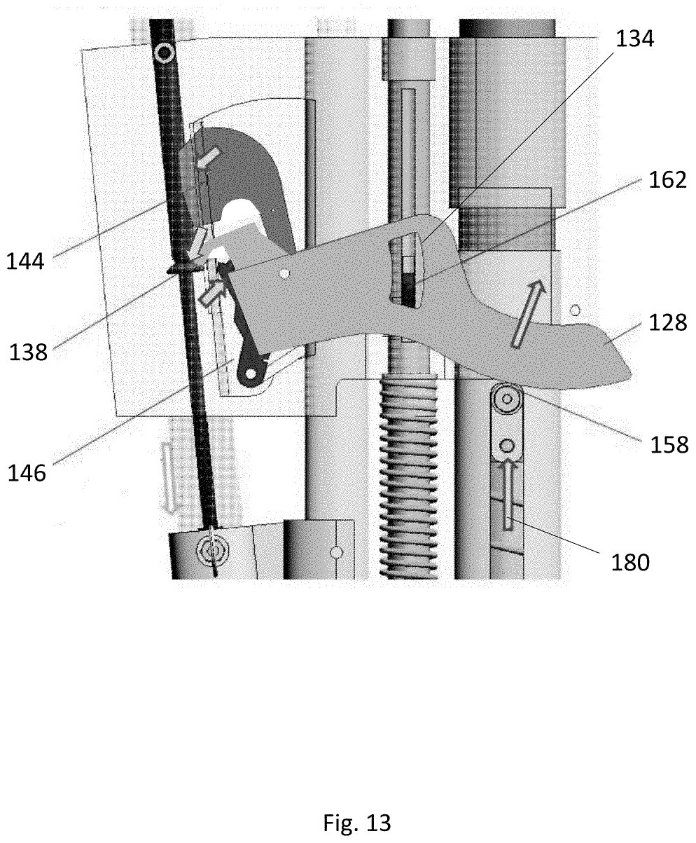

When the operator has completed pressing down on the handle 116 and releases the applied force, the vertical slide roller 158 returns towards the top of the slot and applies a force (in direction 180) to pivot the actuation member 128 back to the top of travel position (see FIG. 13). With this return to the top of travel position, the shank stop lever 144 is engaged with the upper fastener, the head kicker 138 has engaged with the lower fastener (such that the lower fastener drops down into the guide tube below the drive shaft [as a result of the head kicker activation and remaining in position]), and the head stop lever 146 is disengaged. Additionally, the full drive latch 162 is extended through the latch slot 134.

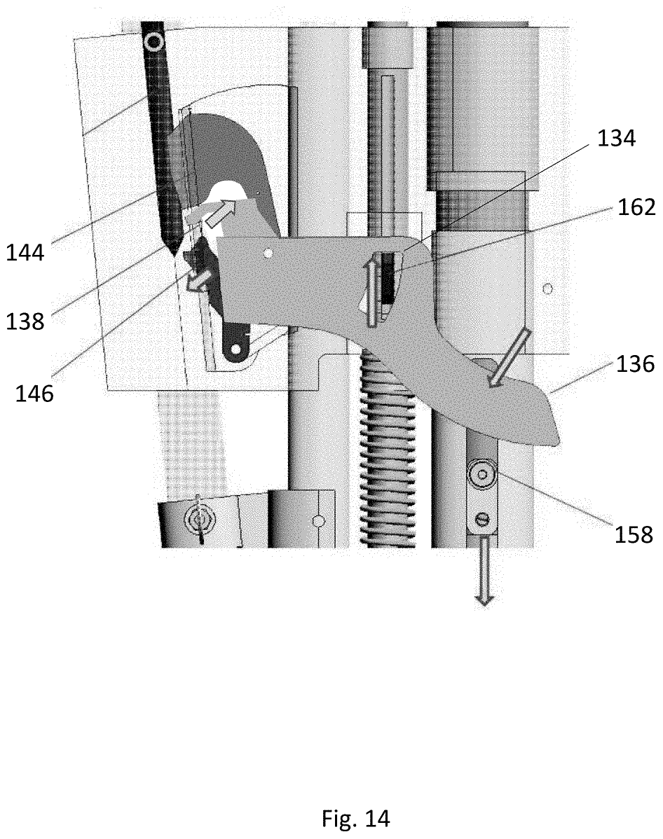

FIG. 14 illustrates a position of partial compression while walking with the fastener installation and plate feeding tool. In this position the vertical slide roller 158 is no longer in contact with the lever portion 136 of the actuation member 128. However, the actuation member 128 is stopped at the mid travel position as the full drive latch 162 is extended through the latch slot 134 (which prevents full swing of the actuation member 128). Additionally, the shank stop lever 144 remains engaged, the head kicker 138 is disengaged, and the head stop lever 146 is in the position of engagement.

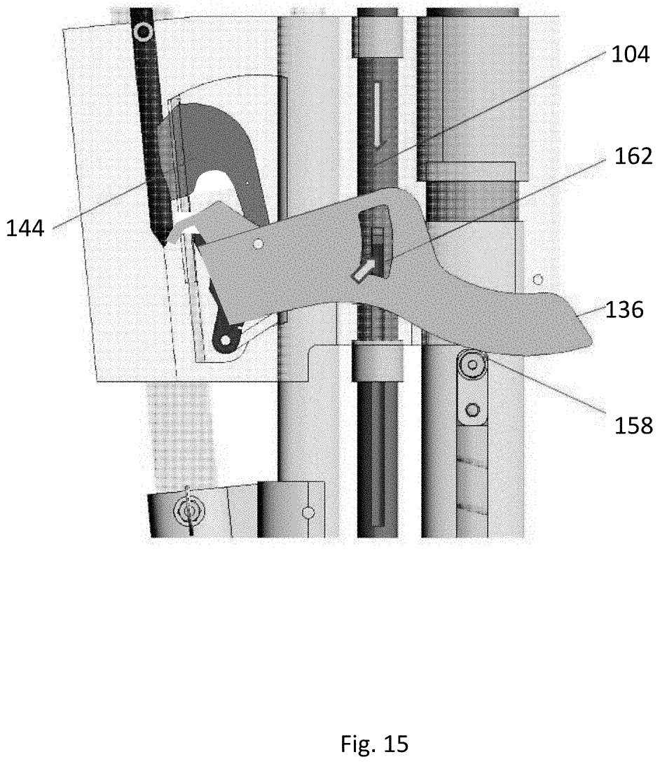

FIG. 15 illustrates a position of manual plate feed for maintenance of the fastener installation and plate feeding tool. In this position, the plate feed actuator 104 is compressed, and the full drive latch 162 is in the retracted position, however with the vertical slide roller 158 in contact with the lever portion 136 (as the handle is not compressed), the actuation member 128 remains at the top of travel position. Additionally, in this position the shank stop lever 144 is engaged with the upper fastener.

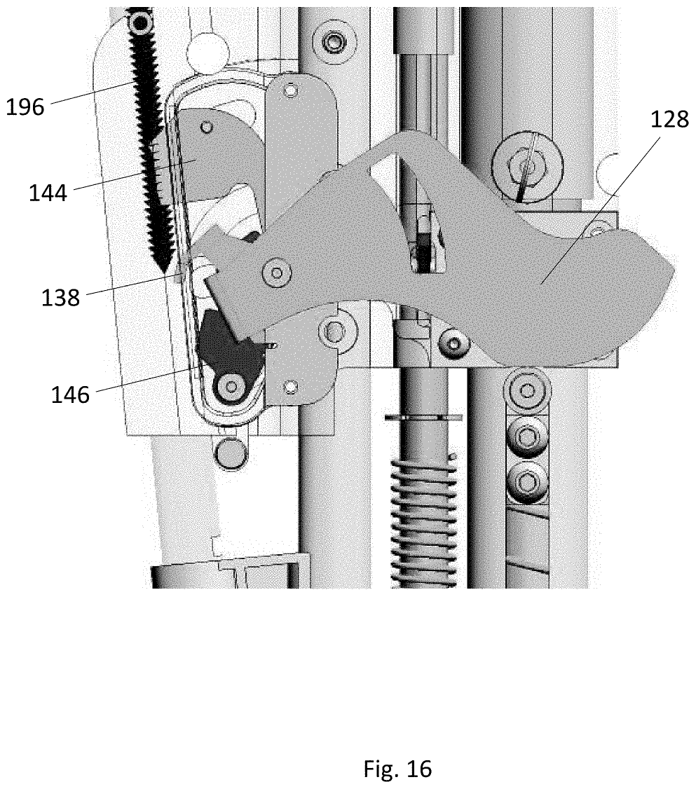

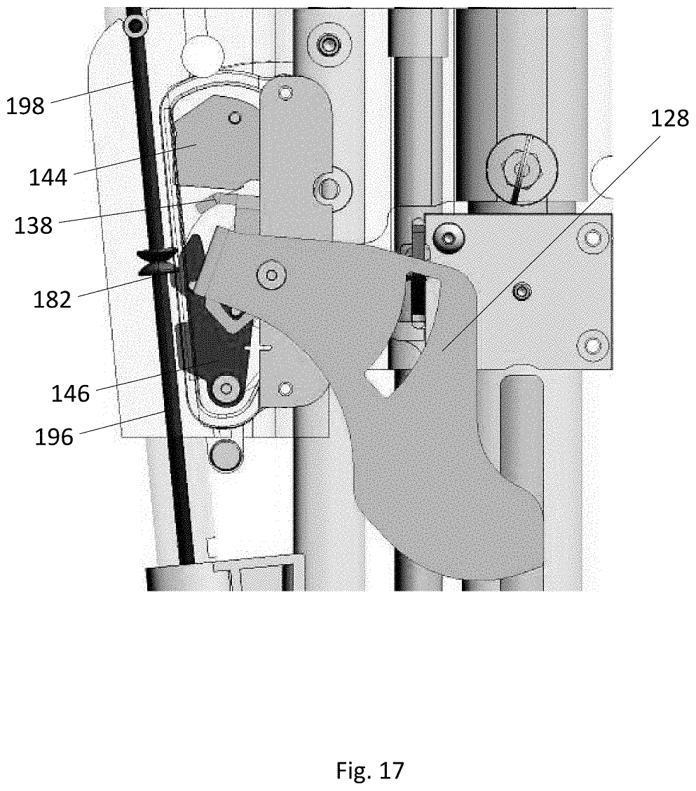

Technical effects of any one or more of the exemplary embodiments also provide functionality to prevent additional fastener feeding when an upside down fastener is inserted into the feed tube. Inadvertent insertion of an upside down fastener into the feed tube can result in a serious jam of the fastener feeding device. This can be a problem in the field during use as a jam in the device leads to unwanted tool down time due to corrective maintenance (i.e. clearing of the jam). An instance of an upside down fastener in the feed tube is shown by way of FIGS. 16 and 17, where FIG. 16 shows the actuation member 128 at the top of travel position and FIG. 17 shows the actuation member 128 at the full compression position. It can be seen in FIG. 16 that the shank stop lever 144 is engaged with the first fastener 196, and in FIG. 17 the head stop lever 146 remains in the full engagement position (and supports the underside of the first fastener 196 at a first protrusion/notch 182), while the shank stop lever 144 and the head kicker portion 138 are disengaged, and the following second fastener 198 is in an “upside down” configuration. It should be noted that FIGS. 16 and 17 generally correspond with the positions in FIGS. 4 and 9, respectively, however FIGS. 4 and 9 illustrate the “right side up” upper and lower fasteners inserted in the feed tube during normal operation (i.e. operations where “right side up” fasteners are loaded in the feed tube).

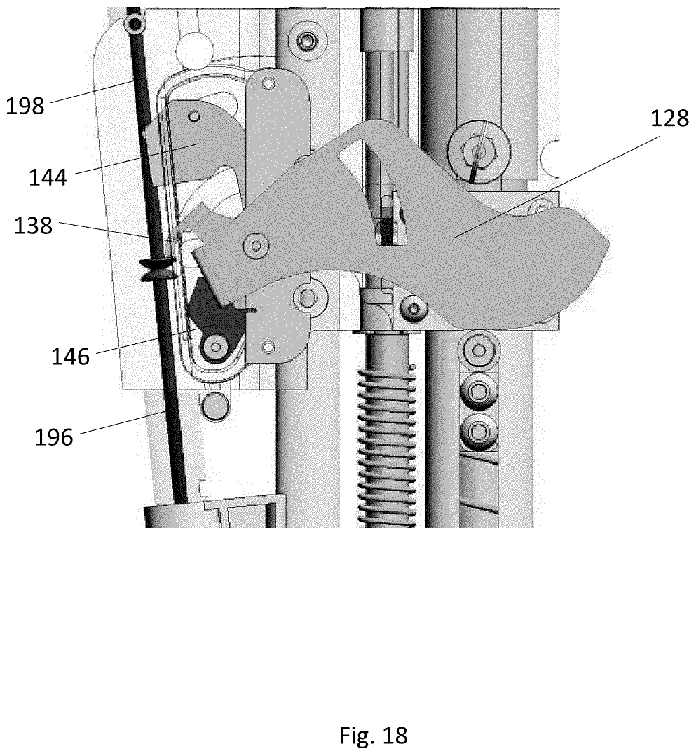

Referring now also to FIGS. 18-21, a full sequence of the (upside down) second fastener 198 will be described as the second fastener 198 travels through the top of travel position, the mid-travel position, the full compression position, and back to the top of travel position.

In FIG. 18 the screw feed mechanism is shown with the actuation member 128 at the top of travel position. In this position, the shank stop lever 144 holds the (upside down) second fastener 198, and the head kicker portion 138 is engaged with the head of the (upside down) second fastener 198 (such that the head kicker pushes down on both fasteners 196, 198). With the head stop lever 146 retracted, this allows the (right side up) first fastener 196 to drop down towards a loading position.

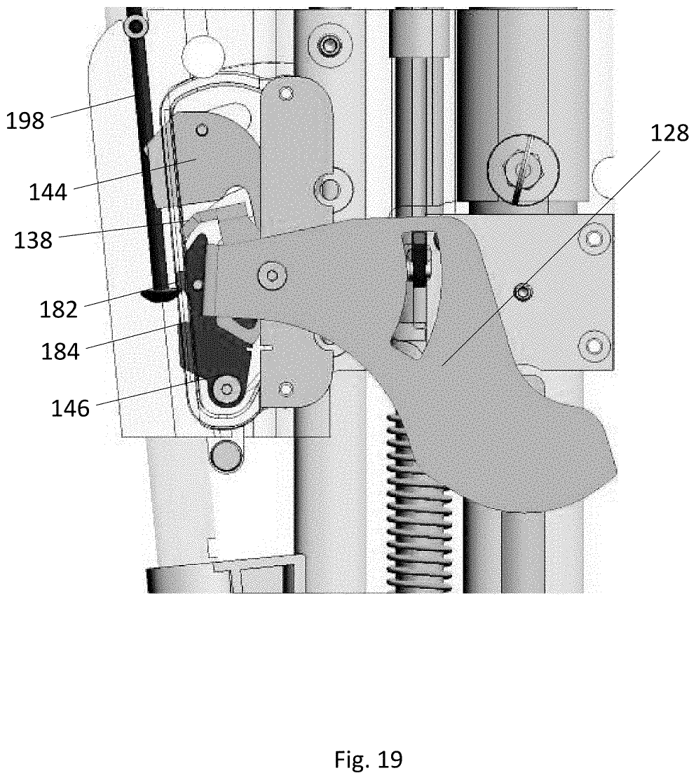

In FIG. 19 where the actuation member is at the mid travel position (or mid-stroke position), the actuation member 128 pivots in a clockwise direction and causes the head kicker 138 to become disengaged (or inactive), but the head stop lever 146 is engaged (while the shank stop lever 144 holds the second fastener 198). In this position, the head of the second fastener 198 is between notches 182, 184 of the head stop lever 146.

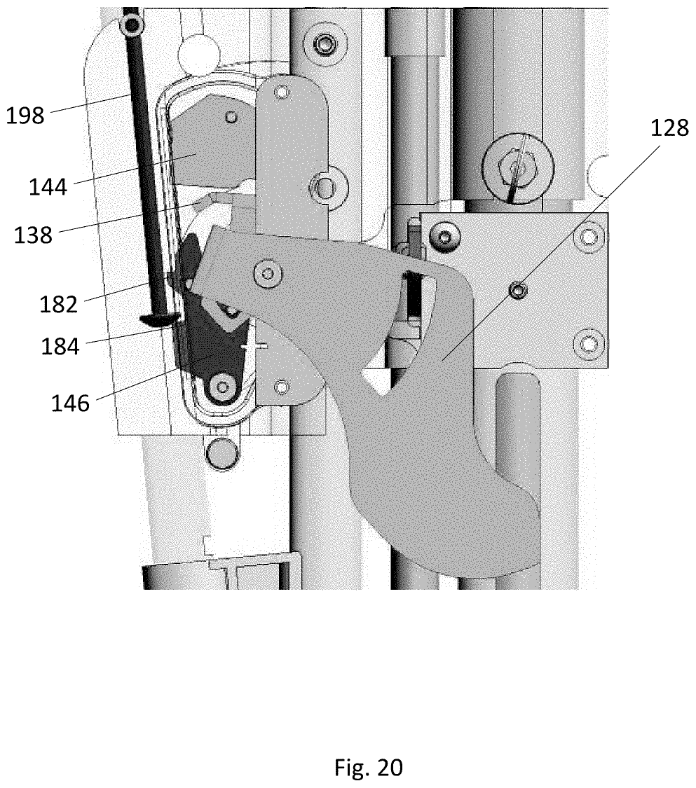

Referring now to FIG. 20, with the actuation member 128 at the full compression position, the shank stop lever 144 is disengaged and allows the second fastener 198 to drop (with the head kicker portion 138 retracted), and the head stop lever 146 remains in the full engagement position which allows the second fastener 198 to drop to the lower notch 184 (within the cavity between notches 182, 184).

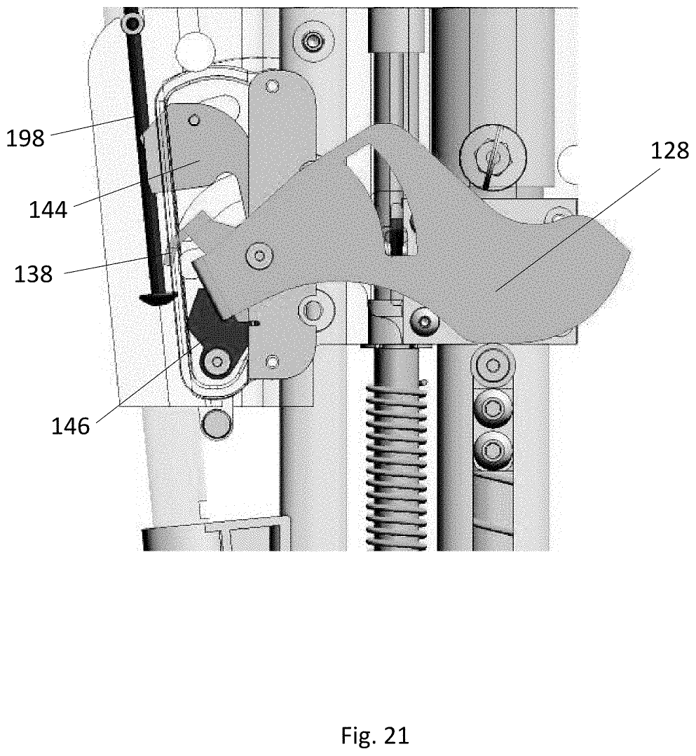

When the tool retracts and returns back to the top of travel position (see FIG. 21), the shank stop lever 144 is engaged (holding the second fastener 198 to remain static), the head kicker 138 is at a position of engagement but does not contact anything as the (upside down) second fastener 198 is held in place by the shank stop lever 144 with the head of the second fastener 198 spaced from the head kicker 138. Additionally, the head stop lever 146 is retracted/disengaged.

When the “upside down” fastener is in the feed tube as shown in FIGS. 17-21, the tool continues to cycle between the “full compression” position of FIG. 20 and the “return to top of travel” position of FIG. 21 without loading a further fastener (until the feed tube is emptied [i.e. removal of the upside down fastener] and filled correctly with “right side up” fasteners).

As can be seen in the sequence of FIGS. 18-21, if an upside down fastener is inserted in the feed tube, it will get pushed down by the head pusher on full retract (FIG. 18). On the next compression, the head stop lever will try to close, and not be able to move fully, allowing the fastener to fall. As it falls, clearance is created for the head stop lever to fully close, and the upside down head will be held on the secondary protrusion/notch (FIGS. 19-20). On the next cycle, the head of the fastener will remain in this position because it is below the head kicker (FIG. 21). The tool will continue to cycle (FIGS. 20, 21), and not feed any more fasteners until the tube is cleared, thereby preventing serious jams.

Technical effects of any one or more of the exemplary embodiments provide a fastener feed device with three components that interact with the fasteners (through an opening along a lateral side of the feed tube) to feed single fasteners to the nose piece. Additional technical effects of any one or more of the exemplary embodiments provide a fastener feed device where three components that interact with the fasteners are connected to and controlled by a single actuation lever. Further technical effects of any one or more of the exemplary embodiments provide a fastener feed device where the feed device is controlled by an actuation lever that interacts with both a telescoping structure of the installation tool and a plate feed actuator separate from the telescoping structure of the installation tool.

It should be understood that components of the various exemplary embodiments can be operationally coupled or connected and that any number or combination of intervening elements can exist (including no intervening elements). The connections can be direct or indirect and additionally there can merely be a functional relationship between components.

Below are provided further descriptions of various non-limiting, exemplary embodiments. The below-described exemplary embodiments may be practiced in conjunction with one or more other aspects or exemplary embodiments. That is, the exemplary embodiments of the invention, such as those described immediately below, may be implemented, practiced or utilized in any combination (e.g., any combination that is suitable, practicable and/or feasible) and are not limited only to those combinations described herein and/or included in the appended claims.

In one exemplary embodiment, a fastener feed device comprising: a guide tube; a feed tube on one side of the guide tube, wherein the feed tube is configured to receive a fastener, and wherein the feed tube comprises an opening; a plate feed actuator proximate the guide tube; a structural member adjacent the plate feed actuator, wherein the structural member comprises a vertical slot; a slide roller movable within the vertical slot of the structural member; a latch connected to the plate feed actuator; an actuation member comprising a head kicker portion, a latch slot, and a lever portion, wherein the head kicker portion is received at the opening of the feed tube, wherein the latch is configured to extend through the latch slot, and wherein the lever portion is proximate the slide roller; a shank stop lever connected to the actuation member; and a head stop lever between the shank stop lever and the feed tube; wherein the head kicker portion, the shank stop lever, and the head stop lever are configured to interact with the fastener.

A fastener feed device as above, wherein the plate feed actuator is on an opposite side of the guide tube, and wherein the plate feed actuator is between the guide tube and the structural member.

A fastener feed device as above, wherein the actuation member includes a general “U” shaped channel.

A fastener feed device as above, wherein the shank stop lever is pivotably mounted to the actuation member.

A fastener feed device as above, wherein the head stop lever is pivotably mounted to a middle tube mount of the fastener feed device.

In another exemplary embodiment, a fastener feed device comprising: a guide tube; a feed tube on one side of the guide tube, wherein the feed tube is configured to receive a fastener, and wherein the feed tube comprises an opening; a plate feed actuator proximate the guide tube; a structural member adjacent the plate feed actuator, wherein the structural member comprises a vertical slot; a slide roller movable within the vertical slot of the structural member; a latch connected to the plate feed actuator; an actuation member comprising a head kicker portion and a latch slot, wherein the head kicker portion is received at the opening of the feed tube, wherein the latch is configured to extend through the latch slot, and wherein the actuation member is proximate the slide roller; a shank stop lever connected to the actuation member; and a head stop lever between the shank stop lever and the feed tube; wherein the head kicker portion, the shank stop lever, and the head stop lever are connected to and configured to be controlled by a single lever portion of the actuation member.

A fastener feed device as above, wherein the plate feed actuator is on an opposite side of the guide tube, and wherein the plate feed actuator is between the guide tube and the structural member.

A fastener feed device as above, wherein the actuation member includes a general “U” shaped channel.

A fastener feed device as above, wherein the shank stop lever is pivotably mounted to the actuation member.

A fastener feed device as above, wherein the head stop lever is pivotably mounted to a middle tube mount of the fastener feed device.

In another exemplary embodiment, a fastener feed device comprising: a guide tube; a feed tube on one side of the guide tube, wherein the feed tube is configured to receive a fastener, and wherein the feed tube comprises an opening; a plate feed actuator proximate the guide tube; a structural member adjacent the plate feed actuator, wherein the structural member comprises a vertical slot; a slide roller movable within the vertical slot of the structural member; a latch connected to the plate feed actuator; an actuation member comprising a head kicker portion and a latch slot, wherein the head kicker portion is received at the opening of the feed tube, wherein the latch is configured to extend through the latch slot, and wherein the actuation member is proximate the slide roller; a shank stop lever connected to the actuation member; and a head stop lever between the shank stop lever and the feed tube; wherein the head kicker portion, the shank stop lever, and the head stop lever are configured to allow a head of an upside down fastener to remain between a first notch and a second notch of the head stop lever when the upside down fastener is in the feed tube.

A fastener feed device as above, wherein when the upside down fastener is in the feed tube, the device is configured to cycle between compressed and retracted positions while the head of the upside down fastener remains between the first notch and the second notch of the head stop lever.

A fastener feed device as above, wherein the plate feed actuator is on an opposite side of the guide tube, and wherein the plate feed actuator is between the guide tube and the structural member.

A fastener feed device as above, wherein the actuation member includes a general “U” shaped channel.

A fastener feed device as above, wherein the shank stop lever is pivotably mounted to the actuation member.

It should be understood that the foregoing description is only illustrative of the various exemplary embodiments. Various alternatives and modifications can be devised by those skilled in the art without departing from the various exemplary embodiments. Accordingly, the various exemplary embodiments are intended to embrace all such alternatives, modifications and variances which fall within the scope of the appended claims.

1. A fastener feed device comprising:
a guide tube;
a feed tube on one side of the guide tube, wherein the feed tube is configured to receive a fastener, and wherein the feed tube comprises an opening;
a plate feed actuator proximate the guide tube;
a structural member adjacent the plate feed actuator, wherein the structural member comprises a vertical slot;
a slide roller movable within the vertical slot of the structural member;
a latch connected to the plate feed actuator;
an actuation member comprising a head kicker portion, a latch slot, and a lever portion, wherein the head kicker portion is received at the opening of the feed tube, wherein the latch is configured to extend through the latch slot, and wherein the lever portion is proximate the slide roller;
a shank stop lever connected to the actuation member; and
a head stop lever between the shank stop lever and the feed tube;
wherein the head kicker portion, the shank stop lever, and the head stop lever are configured to interact with the fastener.

2. The fastener feed device of claim 1, wherein the plate feed actuator is on an opposite side of the guide tube, and wherein the plate feed actuator is between the guide tube and the structural member.

3. The fastener feed device of claim 1, wherein the actuation member includes a general “U” shaped channel.

4. The fastener feed device of claim 1, wherein the shank stop lever is pivotably mounted to the actuation member.

5. The fastener feed device of claim 1, wherein the head stop lever is pivotably mounted to a middle tube mount of the fastener feed device.

6. A fastener feed device comprising:
a guide tube;
a feed tube on one side of the guide tube, wherein the feed tube is configured to receive a fastener, and wherein the feed tube comprises an opening;
a plate feed actuator proximate the guide tube;
a structural member adjacent the plate feed actuator, wherein the structural member comprises a vertical slot;
a slide roller movable within the vertical slot of the structural member;
a latch connected to the plate feed actuator;
an actuation member comprising a head kicker portion and a latch slot, wherein the head kicker portion is received at the opening of the feed tube, wherein the latch is configured to extend through the latch slot, and wherein the actuation member is proximate the slide roller;
a shank stop lever connected to the actuation member; and
a head stop lever between the shank stop lever and the feed tube;
wherein the head kicker portion, the shank stop lever, and the head stop lever are connected to and configured to be controlled by a single lever portion of the actuation member.

7. The fastener feed device of claim 6, wherein the plate feed actuator is on an opposite side of the guide tube, and wherein the plate feed actuator is between the guide tube and the structural member.

8. The fastener feed device of claim 6, wherein the actuation member includes a general “U” shaped channel.

9. The fastener feed device of claim 6, wherein the shank stop lever is pivotably mounted to the actuation member.

10. The fastener feed device of claim 6, wherein the head stop lever is pivotably mounted to a middle tube mount of the fastener feed device.

11. A fastener feed device comprising:
a guide tube;
a feed tube on one side of the guide tube, wherein the feed tube is configured to receive a fastener, and wherein the feed tube comprises an opening;
a plate feed actuator proximate the guide tube;
a structural member adjacent the plate feed actuator, wherein the structural member comprises a vertical slot;
a slide roller movable within the vertical slot of the structural member;
a latch connected to the plate feed actuator;
an actuation member comprising a head kicker portion and a latch slot, wherein the head kicker portion is received at the opening of the feed tube, wherein the latch is configured to extend through the latch slot, and wherein the actuation member is proximate the slide roller;
a shank stop lever connected to the actuation member; and
a head stop lever between the shank stop lever and the feed tube;
wherein the head kicker portion, the shank stop lever, and the head stop lever are configured to allow a head of an upside down fastener to remain between a first notch and a second notch of the head stop lever when the upside down fastener is in the feed tube.

12. The fastener feed device of claim 11, wherein when the upside down fastener is in the feed tube, the device is configured to cycle between compressed and retracted positions while the head of the upside down fastener remains between the first notch and the second notch of the head stop lever.

13. The fastener feed device of claim 11, wherein the plate feed actuator is on an opposite side of the guide tube, and wherein the plate feed actuator is between the guide tube and the structural member.

14. The fastener feed device of claim 11, wherein the actuation member includes a general “U” shaped channel.

15. The fastener feed device of claim 11, wherein the shank stop lever is pivotably mounted to the actuation member.
